(19) United States
(12) Patent Application Publication
(10) Pub. No.: US 2026/0246888 A1
(43) Pub. Date: Aug. 20, 2026

(54) COLOR MANAGEMENT METHOD, COLOR MANAGEMENT APPARATUS AND STORAGE MEDIUM

(71) Applicant: Konica Minolta, Inc., Tokyo (JP)

(72) Inventor: Shigeki NOZAWA, Gifu-shi (JP)

(21) Appl. No.: 19/538,394

(22) Filed: Feb. 12, 2026

(30) Foreign Application Priority Data
Feb. 19, 2025 (JP) 2025-024884

(51) Int. Cl. H04N 1/60; H04N 1/00

(52) U.S. Cl. CPC H04N 1/6044; H04N 1/00724; H04N 1/00726; H04N 1/00779

(57) ABSTRACT

A color management method in a color management apparatus that performs color management including at least one of color verification, color adjustment, and color parameter creation for an image former, the color management method including, acquiring sheet characteristic information regarding a sheet characteristic sensed by a sheet sensor for a sheet used in the color management; and controlling execution of the color management based on the acquired sheet characteristic information.

### CROSS-REFERENCE TO RELATED APPLICATION

The entire disclosure of Japanese Patent Application No. 2025-024884, filed on February 19, 2025, including description, claims, drawings and abstract is incorporated herein by reference.

### BACKGROUND OF THE INVENTION

### Technical Field

The present disclosure relates to a color management method, a color management apparatus, and a storage medium.

### Description of Related Art

In an image forming apparatus used for production printing, color management such as color verification, color adjustment, and color parameter creation is important in order to secure color reproducibility desired by a customer. In the color management, for example, a chart including a plurality of patches is printed by the image forming apparatus, and color verification, color adjustment, and the like are performed based on color measurement data obtained by measuring the color of each patch on the chart. In color management, if a sheet (paper) on which a chart is printed is wrong, color reproducibility changes. Therefore, it is necessary to execute color management by using a correct sheet.

The printing apparatus described in Japanese Unexamined Patent Publication No. 2015-221509 determines a type of paper with a sensor during conveyance of the paper, and switches printing parameters prepared in advance according to the type of paper. The printing parameters are parameters used for color conversion, halftone processing, and the like.

However, the technology described in Japanese Unexamined Patent Publication No. 2015-221509 is not intended to determine the type of sheet (paper) that is the target of color management. That is, the technology described in Japanese Unexamined Patent Publication No. 2015-221509 is not a technology that confirms a correct type of sheet, and then moves on to print a chart on the sheet, to measure the color of the chart, and to create parameters based on the color measurement result. Therefore, in the color management for the image forming apparatus, a wrong sheet may be used, and it has been difficult to secure accurate color reproducibility. For example, there has been a risk that a user may select a wrong sheet or tray on an operation screen, or may set the wrong sheet in the tray.

### SUMMARY OF THE INVENTION

The present disclosure has been made in consideration of the above-described problem in the conventional technology, and an object thereof is to ensure accurate color reproducibility in color management.

To solve the above-described problem, according to one aspect of the present disclosure, a color management method reflecting one aspect of the present disclosure is a color management method in a color management apparatus that performs color management including at least one of color verification, color adjustment, and color parameter creation for an image former, the color management method including: acquiring sheet characteristic information regarding a sheet characteristic sensed by a sheet sensor for a sheet used in the color management; and controlling execution of the color management based on the acquired sheet characteristic information.

According to another aspect of the present disclosure, a color management apparatus executes the above-described color management method.

According to another aspect of the present disclosure, a non-transitory computer-readable storage medium stores a program for causing a computer that controls a color management apparatus to execute the above-described color management method.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a system configuration diagram of a color management system;

FIG. 2 is a block diagram illustrating a hardware configuration of an image forming apparatus;

FIG. 3 is a block diagram illustrating the hardware configuration of a PC;

FIG. 4 is a diagram illustrating an example of a data configuration of a target configuration table;

FIG. 5 is a diagram illustrating an example of a data configuration of a color management preset table;

FIG. 6 is a flowchart illustrating print processing executed in the image forming apparatus;

FIG. 7 is a flowchart illustrating the print processing executed in the image forming apparatus; and

FIG. 8 is a flowchart illustrating color management processing executed in the PC.

### DETAILED DESCRIPTION

Hereinafter, one or more embodiments of the present disclosure will be described with reference to the drawings. However, the scope of the invention is not limited to the disclosed embodiments.

In the following, embodiments of the present disclosure will be described with reference to the drawings. Dimension ratios in the drawings are exaggerated for convenience of explanation and may be different from actual ratios. According to the present embodiment, a sheet includes printing paper and various films. Hereinafter, the printing paper is simply referred to as paper. The paper includes those produced using plant-derived mechanical pulp and/or chemical pulp. In addition, types of paper include gloss paper and matte paper which are coated paper, plain paper and high-quality paper which are non-coated paper, and the like.

### Configuration of Color Management System

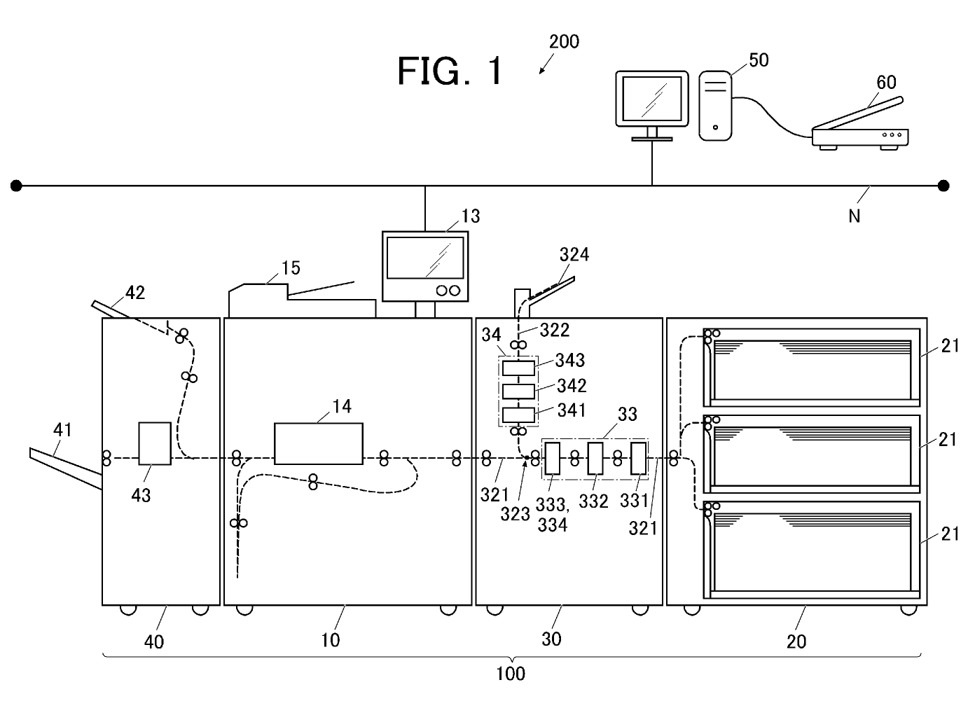

FIG. 1 is a system configuration diagram of a color management system 200 according to the present embodiment. The color management system 200 includes an image forming apparatus 100, a personal computer (PC) 50, and a colorimeter 60. The image forming apparatus 100 and the PC 50 are data-communicably connected via a communication network N such as a network (LAN). Note that the number of image forming apparatuses 100 is not particularly limited.

The image forming apparatus 100 forms an image on paper as a sheet.

The PC 50 performs color management of the image forming apparatus 100.

The colorimeter 60 is connected to the PC 50 via a universal serial bus (USB) cable or the like. The colorimeter 60 measures a color of a patch group included in a chart printed by the image forming apparatus 100 and outputs a colorimetric value (L*a*b* value or the like).

### Configuration of Image Forming Apparatus

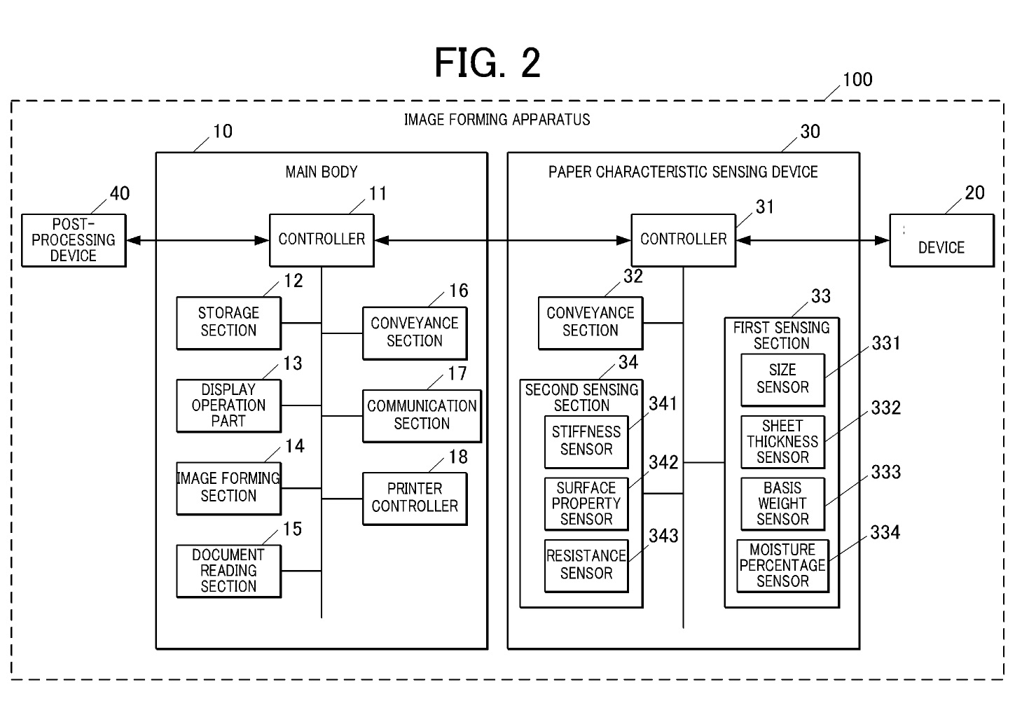

FIG. 2 is a block diagram illustrating a hardware configuration of the image forming apparatus 100. As illustrated in FIGS. 1 and FIG. 2, the image forming apparatus 100 includes a main body 10, a paper feed device 20, a paper characteristic sensing device 30, and a post-processing device 40. The main body 10, the paper feed device 20, the paper characteristic sensing device 30, and the post-processing device 40 are mechanically and electrically connected to each other.

The main body 10 forms an image on a paper sent from the paper characteristic sensing device 30 on the upstream side in a paper conveyance direction. The main body 10 includes a controller 11, a storage section 12, a display operation part 13, an image forming section 14 (image former), a document reading section 15, a conveyance section 16, a communication section 17, a printer controller 18, and the like. The units constituting the main body 10 are connected to each other via a signal line such as a bus.

The controller 11 comprehensively controls processing operation of sections of the main body 10. The controller 11 includes a central processing unit (CPU), a random access memory (RAM), and the like. Specifically, the CPU executes various processes by executing various processing programs stored in the storage section 12.

Further, the controller 11 controls the paper feed device 20. The controller 11 controls the paper characteristic sensing device 30 via the controller 31. The controller 11 controls the post-processing device 40.

The storage section 12 includes a hard disk drive (HDD), a solid state drive (SSD), a nonvolatile memory, and the like. The storage section 12 stores various processing programs and various types of data such as parameters and files necessary for executing the programs. The storage section 12 stores, for each paper feed tray 21 of the paper feed device 20, a paper profile of the paper stored in the paper feed tray 21. The paper profile includes information such as paper brand, paper type, paper passing direction, paper color, paper size (paper width and paper length), paper thickness, basis weight, moisture percentage, stiffness, surface properties, and resistance. The paper type is, for example, gloss coated paper, matt coated paper, plain paper, high-quality paper, rough paper, or the like. Furthermore, the storage section 12 stores a paper characteristic sensing setting for normal printing. The paper characteristic sensing setting for normal printing is information indicating whether to sense a paper characteristic (sheet characteristic) by the paper characteristic sensing device 30 during normal printing.

The display operation part 13 displays various screens according to an instruction of a display signal input from the controller 11. The display operation part 13 includes a touch screen, a numeric keypad, a start button, a stop button and the like. The display operation part 13 accepts various kinds of user operation and outputs an operation signal based on the operation to the controller 11.

The image forming section 14 forms an image by, for example, an electrophotographic method. The image forming section 14 includes photosensitive drums and developing devices corresponding to each basic color of yellow (Y), magenta (M), cyan (C), and black (K). The image forming section 14 further includes an intermediate transfer belt, a secondary transfer section, and a fixing section. The image forming section 14 causes the developing device of the respective colors to form toner images on the photosensitive drums of the respective colors, and superimposes the toner images corresponding to the respective colors on the intermediate transfer belt. The image forming section 14 causes the secondary transfer section to transfer a color toner image on the intermediate transfer belt onto the paper being conveyed. The image forming section 14 heats and pressurizes the color toner image on the paper with the fixing section to fix the image on the paper.

The document reading section 15 reads a document or the like placed on a document plate, and generates read data having pixel values of respective colors of red (R), green (G), and blue (B).

The conveyance section 16 includes a plurality of conveyance rollers provided along a conveyance path, a drive motor that drives these conveyance rollers, and the like. The conveyance section 16 conveys the paper supplied by the paper feed device 20 to the image forming section 14. The conveyance section 16 causes the paper on which the image is formed by the image forming section 14 to be ejected onto paper ejection trays 41 and 42 via the post-processing device 40.

In a case of forming an image also on a back surface of the paper, the conveyance section 16 conveys the paper on which the image has been formed on one surface to the conveyance path for double-sided printing, and reverses the front and back of the paper in a switchback path. Thereafter, the conveyance section 16 causes the paper to merge into the conveyance path for single-sided printing, and conveys the paper again to the image forming section 14.

The communication section 17 is configured by a network interface or the like. The communication section 17 performs data transmission and reception with an external device such as a PC 50 connected via a communication network N.

The printer controller 18 acquires a print job sent from an external device such as the PC 50. The printer controller 18 performs rasterize processing on print data (image data) included in the print job and described in a page description language (PDL) format or a PDF format. The printer controller 18 converts the print data into image data for each page in a raster format.

The paper feed device 20 includes a plurality of paper feed trays 21 that store paper for image formation. The paper feed device 20 supplies paper to the main body 10 via the paper characteristic sensing device 30. The paper feed device 20 feeds the uppermost paper of the plurality of sheets of paper placed in the paper feed tray 21 one by one to the conveyance path on the downstream side. The paper fed from each of the paper feed trays 21 is conveyed to the paper characteristic sensing device 30 on the downstream side.

The post-processing device 40 performs post-processing on the paper sent from the main body 10 or discharges the paper according to the setting of the print job. The post-processing device 40 includes paper ejection trays 41 and 42, a post-processing section 43, and the like. The post-processing section 43 performs at least one of a staple process, a punch process, a cutting process, a folding process, and a bookbinding process on paper on which the image is formed.

The paper characteristic sensing device 30 senses a paper characteristic (sheet characteristic). The paper characteristic sensing device 30 includes a controller 31, a conveyance section 32, a first sensing section 33 (sensor), and a second sensing section 34 (sensor).

The controller 31 comprehensively controls processing operation of each section of the paper characteristic sensing device 30. The controller 31 includes a CPU and a RAM. The controller 31 controls the operation of the first sensing section 33 and the second sensing section 34 to cause them to sense the paper characteristic.

The conveyance section 32 includes a first conveyance path 321, a second conveyance path 322, a branch section 323, and a purge tray 324. The first conveyance path 321 and the second conveyance path 322 include a plurality of conveyance rollers provided along the conveyance path, drive motors that drive these conveyance rollers, and the like.

The first conveyance path 321 is a main conveyance path and extends in a substantially horizontal direction. The paper fed from the paper feed device 20 is conveyed to the first conveyance path 321.

The second conveyance path 322 branches from the first conveyance path 321 at the branch section 323. At least a portion of the second conveyance path 322 extends in a substantial vertical direction (upward). The paper conveyed through the second conveyance path 322 is ejected to the purge tray 324 without passing through the image forming section 14. Hereinafter, the second conveyance path 322 may be referred to as a "vertical conveyance path".

The first sensing section 33 is disposed on the upstream side of the branch section 323 in the first conveyance path 321. The first sensing section 33 includes a size sensor 331, a paper thickness sensor 332, a basis weight sensor 333, and a moisture percentage sensor 334. Each of the sensors 331 to 334 of the first sensing section 33 senses the paper characteristic without stopping the paper conveyed through the first conveyance path 321. Each of the sensors 331 to 334 may output a paper characteristic value itself or a paper physical property value itself, or may output a current, a voltage, or the like corresponding to the characteristic value or the physical property value.

The size sensor 331 is disposed on the most upstream side of the first sensing section 33. The size sensor 331 measures a physical quantity corresponding to the paper size and outputs the measurement result. The size sensor 331 is, for example, an image sensor, and senses an edge of the paper by imaging the conveyed paper.

The paper thickness sensor 332 is arranged at a second position from the upstream side of the first sensing section 33. The paper thickness sensor 332 measures the physical quantity corresponding to a thickness of the paper, and outputs a measurement result. The paper thickness sensor 332 measures the thickness of the paper by, for example, mechanically measuring a displacement amount.

The basis weight sensor 333 and the moisture percentage sensor 334 are arranged on a downstream side of the paper thickness sensor 332. The basis weight sensor 333 and the moisture percentage sensor 334 are disposed side by side at the same position in a conveyance direction of the paper and at different positions in a width direction of the paper. The width direction of the paper is a direction orthogonal to the conveyance direction of the paper, and is a direction connecting the front and the back in the paper characteristic sensing device 30 illustrated in FIG. 1. Such an arrangement of the basis weight sensor 333 and the moisture percentage sensor 334 can reduce a length of the first sensing section 33 as a whole in the conveyance direction, thus achieving a reduction in space.

The basis weight sensor 333 measures the physical quantity corresponding to the basis weight of the paper and outputs the measurement result. The basis weight sensor 333 is, for example, a transmission-type optical sensor and includes a light emitting section and a light receiving section. The basis weight sensor 333 senses the basis weight of the paper by measuring an attenuation amount (transmittance) of light transmitted through the paper.

The moisture percentage sensor 334 measures the physical quantity corresponding to the moisture percentage of the paper, and outputs the measurement result. The moisture percentage sensor 334 may be, for example, a sensor that measures the moisture content of the paper or the sensor that measures an amount of moisture contained in the paper.

The second sensing section 34 is disposed on the second conveyance path 322. The second sensing section 34 includes a stiffness sensor 341, a surface property sensor 342, and a resistance sensor 343. Each of the sensors 341 to 343 of the second sensing section 34 stops the paper at each sensor position, senses a paper characteristic, and sends the paper to the next sensor on the downstream side. Alternatively, each of the sensors 341 to 343 may sense the paper characteristic while conveying the paper at a speed lower than a normal conveyance speed. Each of the sensors 341 to 343 may output the paper characteristic value itself or the paper physical property value itself, or may output a current, a voltage, or the like corresponding to the characteristic value or the physical property value.

The stiffness sensor 341 measures the physical quantity corresponding to the stiffness of the paper and outputs the measurement result. The stiffness sensor 341 senses the stiffness of the paper by, for example, mechanically measuring the displacement amount.

The surface property sensor 342 measures the physical quantity corresponding to the surface properties of the paper, and outputs the measurement result. The surface properties of the paper include the presence or absence of coating on the surface of the paper, the type of coating when coating is present, surface roughness, smoothness, and the like. The surface property sensor 342 is, for example, a reflection-type optical sensor and senses surface properties of the paper based on the absolute values and ratios of the intensities of specular reflection light and scattered reflection light.

The resistance sensor 343 measures the physical quantity corresponding to electrical resistance of the paper and outputs the measurement result. The resistance sensor 343 applies, for example, a high voltage between the front and back of the paper in a stopped state, and senses the electrical resistance (volume electrical resistance) of the paper from the current value that flows.

### Configuration of PC

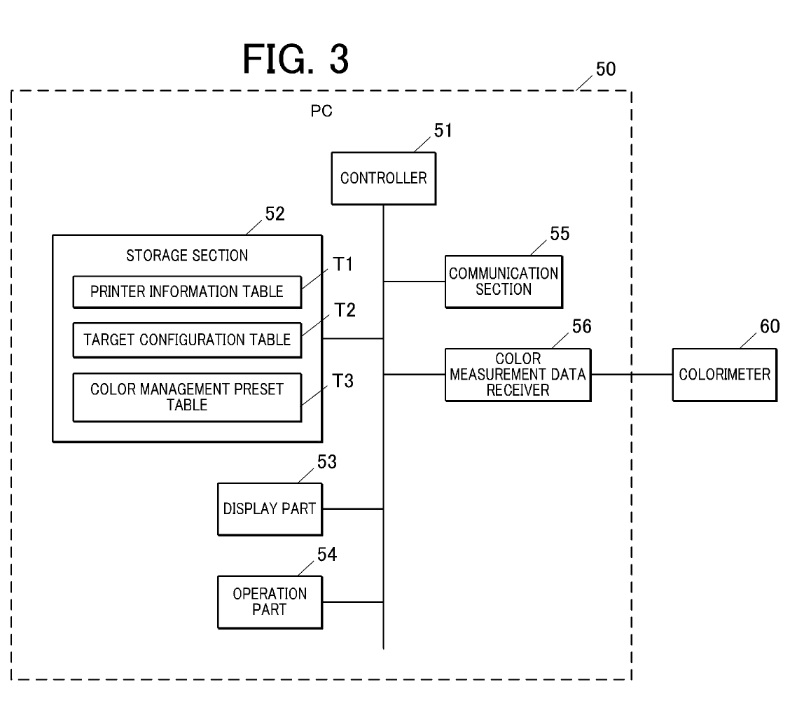

FIG. 3 is a block diagram showing a hardware configuration of the PC 50. As illustrated in FIG. 3, the PC 50 includes a controller 51, a storage section 52, a display part 53, an operation part 54, a communication section 55, a color measurement data receiver 56, and the like. The sections constituting the PC 50 are connected to each other via a signal line such as a bus.

The controller 51 comprehensively controls processing operation of each part of the PC 50. The controller 51 includes a CPU and RAM. Specifically, the CPU executes various processes by executing various processing programs stored in the storage section 52.

The storage section 52 includes an HDD, an SSD, a nonvolatile memory, and the like. The storage section 52 stores various processing programs and various types of data such as parameters and files necessary for executing the programs. The storage section 52 stores a printer information table T1, a target configuration table T2, and a color management preset table T3.

The printer information table T1 is a table for managing printer information of the image forming apparatus 100 in the color management system 200. In the printer information table T1, a printer name, an IP address, paper information, and the like are associated with the respective image forming apparatus 100.

The "printer name" is a name of the image forming apparatus 100.

The "IP address" is an IP address assigned to the image forming apparatus 100.

The "paper information" is information on a paper to be used in the image forming apparatus 100. The "paper information" is information indicating what kind of paper is contained in which paper feed tray.

The target configuration table T2 is a table for managing a target configuration (color management setting). The target configuration is setting information used for color management (color verification, color adjustment, and the like) of the image forming apparatus 100. The target configuration is a setting file in which conditions of color measurement, profile creation, and color verification are set in a state where the image forming apparatus 100 and the paper are not designated.

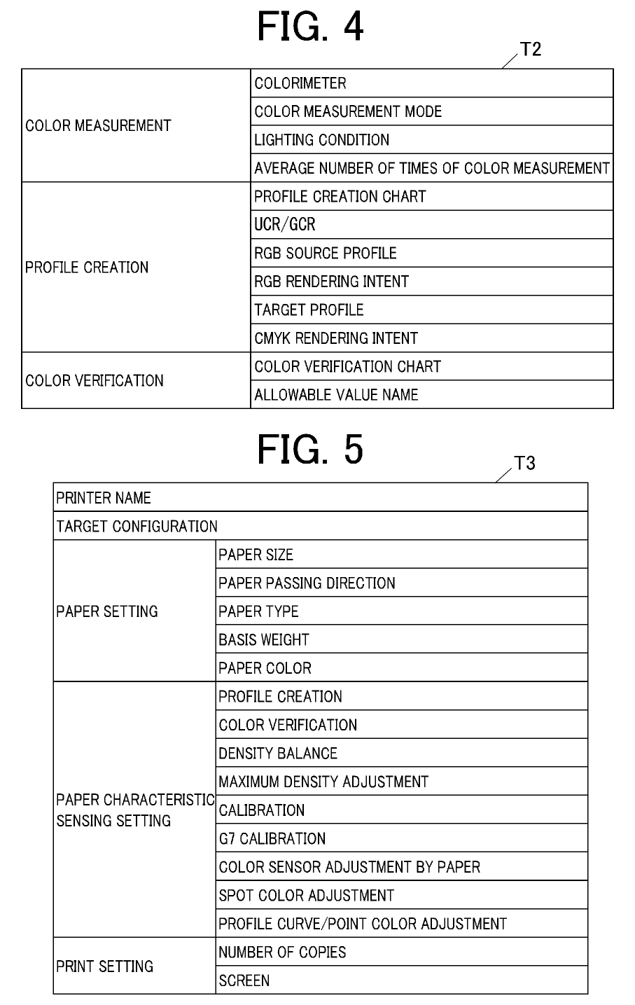

FIG. 4 illustrates an example of the data configuration of the target configuration table T2.

The target configuration includes setting information related to the "color measurement", the "profile creation", and the "color verification".

The setting information related to the "color measurement" includes a colorimeter, a color measurement mode, a lighting condition, and an average number of times of color measurement.

When the colorimetric value is obtained, in consideration of stability during printing, a plurality of copies of the chart are printed, and the colorimetric values are averaged for each patch. The "average number of times of color measurement" is a number of printed copies of the chart used for the averaging.

The setting information related to the "profile creation" is setting information related to creation of a color conversion profile (profiling). The setting information regarding "profile creation" includes a profile creation chart, UCR/GCR, an RGB source profile, an RGB rendering intent, a target profile, and a CMYK rendering intent.

The "profile creation chart" is a file used for creating the color conversion profile.

"UCR (Under Color Removal)" is to replace CMY of a shadow part with a K plate. "GCR (Gray Component Replacement)" is to replace CMY of portions from a highlight portion to a shadow portion that is, all gradation portions, with a K plate.

The setting information related to the "color verification" includes a color verification chart and an allowable value name.

The "color verification chart" is a chart used for color verification.

The "allowable value name" is a name given to a data set related to the setting of the allowable value.

The color management preset table T3 is a table for managing the color management preset. The color management preset is a setting file in which the paper and printing conditions are set in a state where the target configuration and the image forming apparatus 100 are specified.

FIG. 5 illustrates an example of a data configuration of the color management preset table T3.

In a color management preset, the printer name, the target configuration, a paper setting, a paper characteristic sensing setting, and a print setting are associated with each other.

The "printer name" is a name of the image forming apparatus 100 which is a target subjected to color management.

The "target configuration" is information indicating a target configuration used for color management.

The "paper setting" is setting information related to paper used for color management. The "paper setting" includes paper size, paper passing direction, paper type, basis weight, paper color, and the like.

The "paper characteristic sensing setting" includes, for each color management type (color management function), information indicating whether to sense a paper characteristic. Examples of the types of color management include profile creation, color verification, density balance, maximum density adjustment, calibration, G7 calibration, color sensor adjustment for each paper, spot color adjustment and profile curve/point color adjustment.

The "print setting" is setting information related to printing in color management. The "print setting" includes the number of copies, a screen, and the like.

The display part 53 includes a monitor such as an LCD. Various screens are displayed in accordance with an instruction of a display signal input from the controller 51.

The operation part 54 includes a keyboard and a pointing device such as a mouse. The operation part 54 outputs, to the controller 51, an operation signal based on a key operation on the keyboard and an operation on the pointing device.

The communication section 55 is configured by a network interface or the like. The communication section 55 performs data transmission and reception with an external device such as the image forming apparatus 100 connected via the communication network N.

The color measurement data receiver 56 receives colorimetric values (such as L*a* b* values) from the colorimeter 60.

### Outline of Color Management Method

Next, an outline of a color management method in the color management system 200 will be described.

According to the present embodiment, the image forming apparatus 100 and the PC 50 cooperate to form a color management apparatus that executes the color management method.

Color management software is installed in the PC 50. The color management software provides a user interface for giving an instruction to execute each color management function of the image forming apparatus 100, confirming a color measurement result, calculating an adjustment value, and the like.

The controller 51 of the PC 50 executes the color management including at least one of the color verification, the color adjustment, and the color parameter creation for the image forming section 14 of the image forming apparatus 100 (main body 10).

The color verification is a function of comparing a colorimetry result of a chart printed by the image forming apparatus 100 (image forming section 14) with a target value and verifying whether a standard for the color verification is satisfied.

The color adjustment is a function for adjusting the color printed by the image forming apparatus 100 (image forming section 14). Examples of the color adjustment include the density balance, the maximum density adjustment, the calibration, the G7 calibration, the color sensor adjustment for each paper, the spot color adjustment, and the profile curve/point color adjustment.

The color parameter creation is a function of creating a color parameter indicating a color reproduction characteristic of the image forming apparatus 100 (image forming section 14). The color parameter is a color conversion file or the like. The color parameter creation (profile creation) may be one type of the color adjustment.

The controller 11 of the image forming apparatus 100 (main body 10) acquires information on the paper characteristic (sheet characteristic) sensed by the paper characteristic sensing device 30 (sheet characteristic sensing section) for the paper used for the color management. The "information on the paper characteristic" may be information indicating the paper characteristic or may be information that may change depending on the characteristic of the paper. Hereinafter, the " information on the paper characteristic" may be referred to as "paper characteristic information".

The controller 11 controls execution of the color management on the basis of the acquired information regarding the paper characteristic. Specifically, the controller 11 controls the execution of the printing of the color management chart on the basis of the information regarding the paper characteristic. The controller 51 of the PC 50 controls the execution of the color management in accordance with execution control related to printing of the color management chart in the image forming apparatus 100.

In the storage section 12 of the image forming apparatus 100 (main body 10), a first reference range related to the paper characteristic is registered in advance for the paper to be used for the color management. The first reference range is prepared for each paper (paper profile) to be used. Hereinafter, the first reference range is referred to as a "first range".

For example, for the paper used for the color management, a reference value and a first allowable width are stored in advance in the storage section 12 for each of the items of the paper characteristic (size, paper thickness, basis weight, moisture percentage, stiffness, surface properties, and resistance), and thus the "first range" is determined. The reference value is information on the paper characteristic sensed by the first sensing section 33 or the second sensing section 34 as the paper profile. A lower limit value of the first range is a value obtained by subtracting the first allowable width from the reference value, and an upper limit value of the first range is a value obtained by adding the first allowable width to the reference value. The lower limit and the upper limit (boundary values) may or may not be included in the first range. Note that as the first range, the lower limit value and the upper limit value may be stored in advance in the storage section 12. Furthermore, the first range may be defined by only the lower limit value or only the upper limit value.

Furthermore, in the storage section 12, a second reference range related to the paper characteristic is registered in advance for the paper to be used for the print job by the image forming section 14. The second reference range is prepared for each paper (paper profile) to be used. Hereinafter, the second reference range is referred to as a "second range".

For example, for the paper to be used for the print job, the reference value and a second allowable width are stored in advance in the storage section 12 for each of the items (size, paper thickness, basis weight, moisture percentage, stiffness, surface properties, and resistance) of the paper characteristic, and thus the "second range" is determined. The "reference value" for the paper to be used for the print job is the same value as the above-described "reference value" for the paper to be used for the color management. The lower limit value of the second range is the value obtained by subtracting the second allowable width from the reference value, and the upper limit value of the second range is the value obtained by adding the second allowable width to the reference value. The lower limit value and the upper limit value (boundary values) may or may not be included in the second range. Note that as the second range, the lower limit value and the upper limit value may be stored in advance in the storage section 12. Furthermore, the second range may be defined by only the lower limit value or only the upper limit value.

The second range is wider than the first range. The second allowable width is greater than the first allowable width. That is, the range of the allowable paper characteristic is narrower when the color management is executed than when the print job is executed. Due to the variation in the paper characteristic, the sensed paper characteristic may deviate from the reference value. In the color management, it is desirable to print and perform color measurement of the chart on the paper having small variations in the paper characteristic.

In the PC 50, when the color management is executed, the controller 11 of the image forming apparatus 100 (main body 10) performs the following processes (A), (B) and (C).
(A) The controller 11 acquires the information on the paper characteristic sensed by the paper characteristic sensing device 30 for the first paper of the paper used for the color management.
(B) In a case in which the information relating to the paper characteristic is not included in the first range, the controller 11 provides notification that the information is not included in the first range.
(C) In a case in which the information on the paper characteristic is not included in the first range, the controller 11 prohibits the execution of the color management by the PC 50.

The controller 11 may perform only one of the processes (B) and (C).

The paper characteristic sensing device 30 (sheet characteristic sensing section) includes a first mode and a second mode for sensing the paper characteristic.

The first mode is a mode in which the paper characteristic according to a first combination can be sensed. According to the present embodiment, the first combination includes the size, the sheet thickness, the basis weight, and the moisture percentage.

The second mode is a mode in which more paper characteristics than the first combination can be sensed. According to the present embodiment, the size, the sheet thickness, the basis weight, the moisture percentage, the stiffness, the surface properties, and the resistance can be sensed in the second mode.

In the first mode, the paper is conveyed to the main body 10 via the first conveyance path 321. In the first mode, the first sensing section 33 senses the paper characteristic. Specifically, the sensors 331 to 334 of the first sensing section 33 sense the size, the paper thickness, the basis weight, and the moisture percentage of the paper.

In the second mode, the paper is conveyed from the first conveyance path 321 to the second conveyance path 322 via the branch section 323. In the second mode, the first sensing section 33 and the second sensing section 34 sense the paper characteristic. Specifically, the sensors 331 to 334 of the first sensing section 33 and the sensors 341 to 343 of the second sensing section 34 sense the size, the paper thickness, the basis weight, the moisture percentage, the stiffness, the surface properties, and the resistance of the paper. That is, the second conveyance path 322 is a path along which the paper is conveyed when the sensing of the paper characteristic is performed in detail.

The controller 11 of the image forming apparatus 100 (main body 10) acquires the information on the paper characteristic of the first paper in the paper used for the color management sensed by the paper characteristic sensing device 30 in the second mode. The controller 11 acquires the information regarding the paper characteristic sensed by the seven sensors 331 to 334 and 341 to 343 of the first sensing section 33 and the second sensing section 34 for the first paper.

The controller 11 acquires the information on the paper characteristic sensed by the paper characteristic sensing device 30 in the first mode for the second and subsequent paper of the paper used for the color management. The controller 11 acquires the information on the paper characteristic sensed by the four sensors 331 to 334 of the first sensing section 33 for the second and subsequent paper.

In the storage section 52 of the PC 50, whether or not to perform sensing by the paper characteristic sensing device 30 (sheet characteristic sensing section) is set as a setting value of a data set (color management preset) used for the color management. Specifically, in the color management preset table T3, whether or not sensing by the paper characteristic sensing device 30 is performed is set for each of the color verification, the color adjustment, and the color parameter creation.

When it is set to perform sensing by the paper characteristic sensing device 30, the controller 11 of the image forming apparatus 100 (main body 10) acquires the information on the paper characteristic sensed by the paper characteristic sensing device 30 for the paper used in the color management. The controller 11 controls the execution of the color management on the basis of the acquired information regarding the paper characteristic.

In a case in which the color parameter creation for the image forming section 14 of the image forming apparatus 100 (main body 10) is executed as the color management, the controller 51 of the PC 50 records the information on the paper characteristic sensed by the paper characteristic sensing device 30 in association with the created color parameter.

For example, the controller 51 embeds the information on the paper characteristic sensed by the paper characteristic sensing device 30 in the created information on the color parameters. Note that there is no limitation on the method of association as long as both information are recorded so that the correspondence relationship between the color parameters and the information relating to the paper characteristic can be understood.

In the image forming apparatus 100 (main body 10), when the image forming section 14 executes the print job, the controller 11 performs the following processes (D), (E), and (F).

(D) The controller 11 acquires the information relating to the paper characteristic sensed by the paper characteristic sensing device 30 for the paper used in the print job.

(E) In a case in which the information relating to the paper characteristic is not included in the second range, the controller 11 provides notification that the information is not included in the second range.

(F) In a case in which the information relating to the paper characteristic is not included in the second range, the controller 11 stops the execution of the print job.

Note that the controller 11 may perform only one of the processes (E) and (F).

### Operation in Color Management System

Next, the operation of the color management system 200 will be described.

### Paper Profile Registration Processing in Image Forming Apparatus

The process of registering the paper profile for the new paper in the image forming apparatus 100 (main body 10) will be described.

The user places the new paper in one of the paper feed trays 21 of the paper feed device 20. The user designates the paper feed tray 21 in which the paper is set and instructs the registration of the paper profile by the operation from the display operation part 13.

The controller 11 controls the paper feed device 20 to supply the new paper to the paper characteristic sensing device 30. The controller 11 controls the paper characteristic sensing device 30 to cause the paper to be conveyed to the first conveyance path 321 and cause the first sensing section 33 to sense the paper characteristic. The controller 31 of the paper characteristic sensing device 30 controls the conveyance section 32 and the first sensing section 33 to cause the first sensing section 33 to sense the paper characteristic of the paper conveyed through the first conveyance path 321. The controller 11 acquires the sensing result (paper characteristic information) by the size sensor 331, the paper thickness sensor 332, the basis weight sensor 333, and the moisture percentage sensor 334 from the paper characteristic sensing device 30.

Next, the controller 11 controls the paper characteristic sensing device 30 to cause the paper to be conveyed to the vertical conveyance path (second conveyance path 322) and cause the second sensing section 34 to sense the paper characteristic. The controller 31 of the paper characteristic sensing device 30 controls the conveyance section 32 and the second sensing section 34 to convey the paper from the branch section 323 to the second conveyance path 322 and to sense the paper characteristic of the paper by the second sensing section 34. The controller 11 acquires the sensing result (paper characteristic information) by the stiffness sensor 341, the surface property sensor 342, and the resistance sensor 343 from the paper characteristic sensing device 30. The controller 31 of the paper characteristic sensing device 30 controls the conveyance section 32 to cause the paper whose paper characteristic has been sensed by the second sensing section 34 to be ejected onto the purge tray 324.

Next, the controller 11 stores the paper characteristic sensed by the first sensing section 33 and the second sensing section 34 as the paper profile in the storage section 12 in association with the used paper feed tray 21. The information in the paper profile other than the paper characteristic sensed by the first sensing section 33 or the second sensing section 34 is input from the display operation part 13 by the user operation.

### Print Processing in Image Forming Apparatus

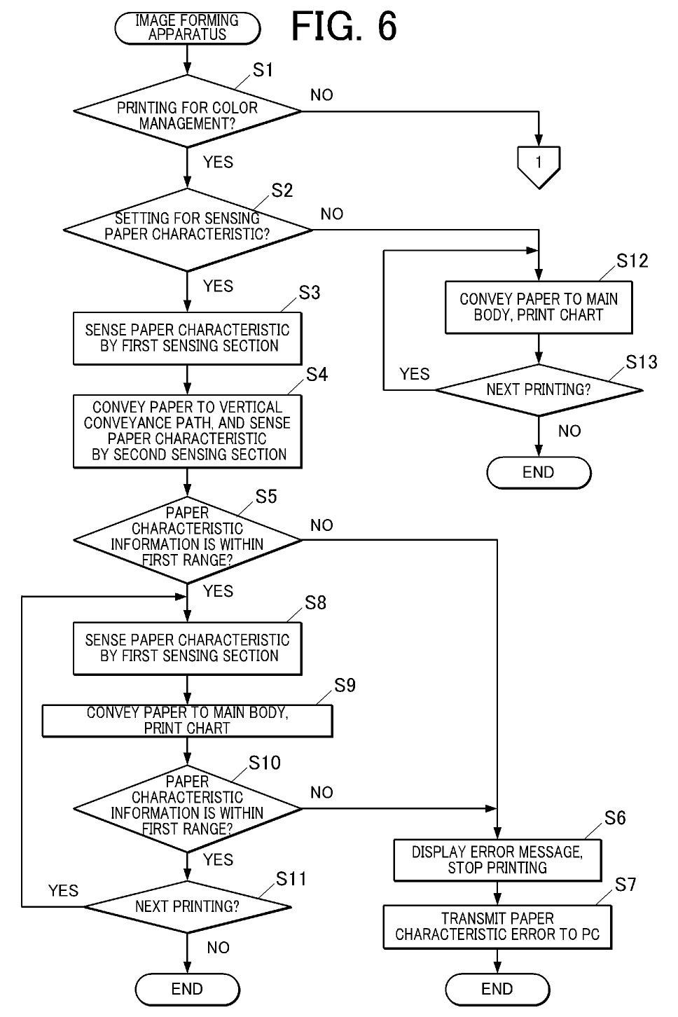

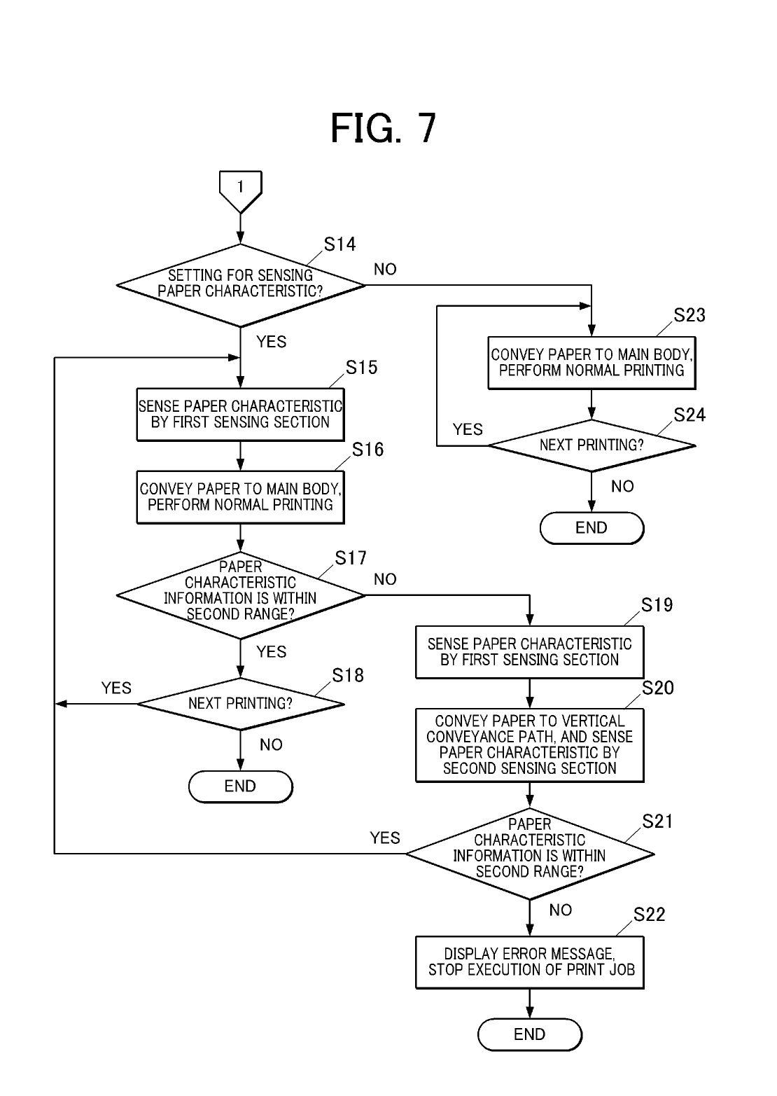

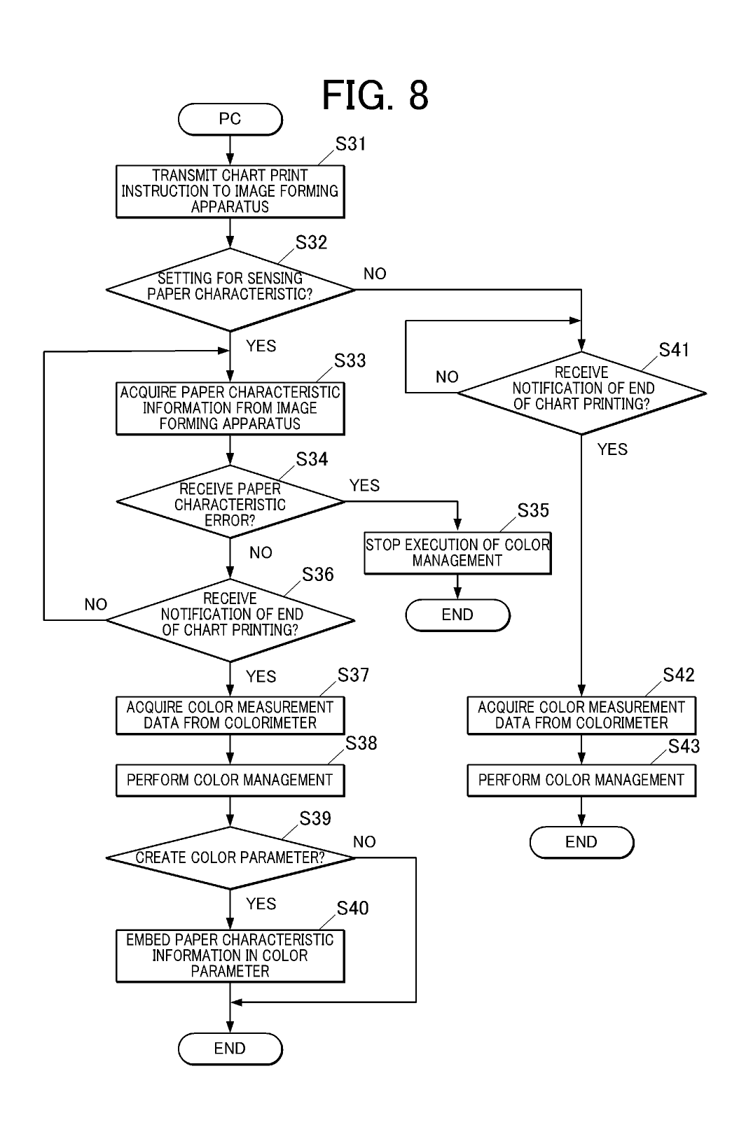

FIGS. 6 and FIG. 7 are flowcharts illustrating the print processing to be executed in the image forming apparatus 100 (main body 10).

First, the controller 11 of the main body 10 determines whether the printing to be executed is the printing for the color management (step S1). For example, in a case in which a chart print instruction for the color management is received from the PC 50 via the communication section 17, the controller 11 determines that the printing is for the color management. The chart print instruction for the color management includes the image data of the color management chart and the setting information.

In a case in which the "color verification" is performed as the color management, the color management chart is a color verification chart. In a case in which the "profile creation" is performed as the color management, the color management chart is the profile creation chart. In a case in which the "color adjustment" is performed as the color management, the color management chart is the chart corresponding to various types of the color adjustment.

The setting information includes the "paper setting" and the "print setting" associated with the "image forming apparatus 100 (printer name)" of the color management target in the "color management preset" managed in the PC 50, and the "paper characteristic sensing setting" corresponding to the type of the current color management. For example, in a case in which the type of the current color management is "color verification", the setting information includes the "paper characteristic sensing setting" corresponding to the "color verification".

In a case in which the printing to be executed is printing for the color management (step S1; YES), the controller 11 determines whether it is set to perform the sensing of the paper characteristic (step S2). Specifically, the controller 11 determines, based on the information on the "paper characteristic sensing setting" corresponding to the type of the current color management, whether the sensing of the paper characteristic is set.

In a case in which it is set to perform the sensing of the paper characteristic (step S2; YES), the controller 11 controls the paper feed device 20 to supply one sheet of paper from the paper feed tray 21 corresponding to the paper designated by the "paper setting" to the paper characteristic sensing device 30. The controller 11 controls the paper characteristic sensing device 30 to cause the paper to be conveyed to the first conveyance path 321 and cause the first sensing section 33 to sense the paper characteristic (step S3). The controller 31 of the paper characteristic sensing device 30 controls the conveyance section 32 and the first sensing section 33 to cause the first sensing section 33 to sense the paper characteristic of the paper conveyed through the first conveyance path 321. The controller 11 acquires the sensing result (paper characteristic information) by the size sensor 331, the paper thickness sensor 332, the basis weight sensor 333, and the moisture percentage sensor 334 from the paper characteristic sensing device 30.

Next, the controller 11 controls the paper characteristic sensing device 30 to cause the paper to be conveyed to the vertical conveyance path (second conveyance path 322) and cause the second sensing section 34 to sense the paper characteristic (step S4). The controller 31 of the paper characteristic sensing device 30 controls the conveyance section 32 and the second sensing section 34 to convey the paper from the branch section 323 to the second conveyance path 322 and to sense the paper characteristic of the paper by the second sensing section 34. The controller 11 acquires the sensing result (paper characteristic information) by the stiffness sensor 341, the surface property sensor 342, and the resistance sensor 343 from the paper characteristic sensing device 30. The controller 31 of the paper characteristic sensing device 30 controls the conveyance section 32 to cause the paper whose paper characteristic has been sensed by the second sensing section 34 to be ejected onto the purge tray 324.

As described above, in a case in which it is set to perform sensing of the paper characteristic for the type of the color management to be executed, the paper characteristic of the first paper to be passed during the color management is sensed in detail by the first sensing section 33 and the second sensing section 34 (second mode).

In addition, the controller 11 transmits the paper characteristic information (sensing results of the seven sensors) obtained by the first sensing section 33 and the second sensing section 34 to the PC 50 via the communication section 17.

Next, the controller 11 determines whether or not the paper characteristic information (the sensing results of the seven sensors) of the first paper at the time of executing the color management is included in the first range corresponding to the paper designated by the "paper setting" (step S5). The controller 11 determines, for each of the items (size, paper thickness, basis weight, moisture percentage, stiffness, surface properties, and resistance) of the paper characteristic, whether the paper characteristic information is included in the first range. In a case in which the paper characteristic information falls within the first range with respect to all of the sensed items, the controller 11 determines that the sensed paper characteristic matches the paper characteristic of the paper to be used for the color management.

In a case in which the paper characteristic information of the first paper at the time of execution of the color management is not included in the first range (step S5; NO), the controller 11 allows the display operation part 13 to display an error message, and temporarily stops printing by the image forming section 14 (step S6). For example, the controller 11 displays a message which provides notification that the sensed paper characteristic does not match the paper characteristic of the paper to be used for the color management, a message to promote confirmation as to whether the paper is correctly set, or the like.

The controller 11 also transmits a paper characteristic error to the PC 50 via the communication section 17 (step S7). Thus, the print processing ends.

In step S5, if the paper characteristic information of the first paper at the time of execution of the color management is within the first range (step S5; YES), the process proceeds to step S8. In step S8, the controller 11 controls the paper feed device 20 to supply the paper to the paper characteristic sensing device 30 from the paper feed tray 21 corresponding to the paper specified in the "paper setting". The controller 11 controls the paper characteristic sensing device 30 to cause the paper to be conveyed to the first conveyance path 321 and cause the first sensing section 33 to sense the paper characteristic. The controller 31 of the paper characteristic sensing device 30 controls the conveyance section 32 and the first sensing section 33 to cause the first sensing section 33 to sense the paper characteristic of the paper conveyed through the first conveyance path 321. The controller 11 acquires the sensing result (paper characteristic information) by the size sensor 331, the paper thickness sensor 332, the basis weight sensor 333, and the moisture percentage sensor 334 from the paper characteristic sensing device 30.

As described above, in a case in which it is set to perform sensing of the paper characteristic for the type of color management to be executed, the paper characteristic of the second and subsequent paper to be passed during the color management are sensed by only the first sensing section 33 (first mode).

In addition, the controller 11 transmits the paper characteristic information (sensing results of the four sensors) obtained by the first sensing section 33 to the PC 50 via the communication section 17.

Next, the controller 11 controls the paper characteristic sensing device 30 to cause the paper whose paper characteristic has been sensed by the first sensing section 33 to be conveyed to the main body 10 via the branch section 323, and controls the image forming section 14 to cause the color management chart to be printed (step S9).

Here, the controller 11 determines whether or not the paper characteristic information (sensing results of the four sensors) of the paper sensed in step S8 (the second and subsequent papers at the time of executing the color management) is included in the first range corresponding to the paper designated in the "paper setting" (step S10). The controller 11 determines, for each of the items (size, paper thickness, basis weight, and moisture percentage) of the paper characteristic, whether the paper characteristic information is included in the first range. In a case in which the paper characteristic information falls within the first range with respect to all of the sensed items, the controller 11 determines that the sensed paper characteristic matches the paper characteristic of the paper to be used for the color management.

In a case in which the paper characteristic information of the paper sensed in step S8 is not included in the first range (step S10; NO), the controller 11 controls the post-processing device 40 to cause the paper to be ejected to the paper ejection tray different from the paper ejection tray to which a normal chart paper is ejected. Next, the processing proceeds to step S6.

In step S10, in a case in which the paper characteristic information of the paper sensed in step S8 is included in the first range (step S10; YES), the controller 11 controls the post-processing device 40 to eject the paper to the paper ejection tray to which the normal chart paper is ejected.

Next, the controller 11 determines whether or not there is next printing (printing of a chart) (step S11). In a case in which there is the next printing (step S11; YES), the process returns to step S8. The processing is repeated the number of times corresponding to the number of sheets of the color management chart.

In step S11, in a case in which there is no next printing (step S11; NO), that is, in a case in which printing of all the charts is completed, the print processing is completed. The controller 11 sends the information indicating that the printing of the color management chart is completed (chart printing completion notification) to the PC 50 via the communication section 17.

In step S2, in a case in which it is set not to perform the sensing of the paper characteristic (step S2; NO), the process proceeds to step S12. In step S12, the controller 11 controls the paper feed device 20 to supply the paper to the paper characteristic sensing device 30 from the paper feed tray 21 corresponding to the paper specified in the "paper setting". The controller 11 controls the paper characteristic sensing device 30 to convey the paper supplied from the paper feed device 20 to the main body 10, and controls the image forming section 14 to print the color management chart. The controller 11 controls the post-processing device 40 to discharge the paper on which the color management chart is printed to the paper ejection tray to which the normal chart paper is discharged.

Next, the controller 11 determines whether or not there is the next printing (printing of the chart) (step S13). In a case in which there is the next printing (step S13; YES), the process returns to step S12.

In step S13, in a case in which there is no next printing (step S13; NO), that is, in a case in which printing of all the charts is completed, the print processing is completed. The controller 11 sends the information indicating that the printing of the color management chart is completed (chart printing completion notification) to the PC 50 via the communication section 17.

In step S1, in a case in which the printing to be executed is not printing for the color management (step S1; NO), that is, in a case in which the printing is printing related to the normal print job, the process proceeds to step S14 in FIG. 7. The normal print job may be the print job received from the external device or the print job involving image formation based on read data generated by the document reading section 15. In step S14, the controller 11 determines whether it is set to perform the sensing of the paper characteristic. Specifically, the controller 11 determines, based on the information on the "paper characteristic sensing setting" in the normal printing stored in the storage section 12, whether the sensing of the paper characteristic is set.

In a case in which it is set to perform sensing of the paper characteristic (step S14; YES), the processing proceeds to step S15. In step S15, the controller 11 controls the paper feed device 20 to supply the paper from the paper feed tray 21 corresponding to the paper designated by the print job to the paper characteristic sensing device 30. The controller 11 controls the paper characteristic sensing device 30 to cause the paper to be conveyed to the first conveyance path 321 and cause the first sensing section 33 to sense the paper characteristic. The controller 31 of the paper characteristic sensing device 30 controls the conveyance section 32 and the first sensing section 33 to cause the first sensing section 33 to sense the paper characteristic of the paper conveyed through the first conveyance path 321. The controller 11 acquires the sensing result (paper characteristic information) by the size sensor 331, the paper thickness sensor 332, the basis weight sensor 333, and the moisture percentage sensor 334 from the paper characteristic sensing device 30.

In this way, in a case in which it is set to perform sensing of the paper characteristic in the normal printing, the paper characteristic is sensed only by the first sensing section 33 (four sensors) with respect to the paper passed in the normal printing.

Next, the controller 11 controls the paper characteristic sensing device 30 to convey the paper whose paper characteristic has been sensed by the first sensing section 33 to the main body 10 via the branch section 323, and controls the image forming section 14 to perform the normal printing based on the print job (step S16).

Here, the controller 11 determines whether or not the paper characteristic information (the sensing results of the four sensors) of the paper sensed in step S15 is included in the second range corresponding to the paper designated in the print job (step S17). The controller 11 determines, for each of the items (size, paper thickness, basis weight, and moisture percentage) of the paper characteristic, whether the paper characteristic information is included in the second range. In a case in which the paper characteristic information is within the second range with respect to all the sensed items, the controller 11 determines that the sensed paper characteristic matches the paper characteristic of the paper to be used for the print job.

In a case in which the paper characteristic information of the paper sensed in step S15 is within the second range (step S17; YES), the controller 11 controls the post-processing device 40 to eject the paper to the normal paper ejection tray.

Next, the controller 11 determines whether or not there is the next printing (normal printing) (step S18). In a case in which there is the next printing (step S18; YES), the process returns to step S15. The processing is repeated for the number of pages to be printed in the print job.

In step S18, when there is no next printing (step S18; NO), that is, when the normal printing based on the print job is finished, the print processing is finished.

In step S17, when the paper characteristic information of the paper sensed in step S15 is not included in the second range (step S17; NO), the controller 11 controls the post-processing device 40 to eject the paper to the paper ejection tray different from the normal paper ejection tray.

Next, the controller 11 controls the paper feed device 20 to supply the paper to the paper characteristic sensing device 30 from the paper feed tray 21 corresponding to the paper designated by the print job. The controller 11 controls the paper characteristic sensing device 30 to cause the paper to be conveyed to the first conveyance path 321 and cause the first sensing section 33 to sense the paper characteristic (step S19). The controller 31 of the paper characteristic sensing device 30 controls the conveyance section 32 and the first sensing section 33 to cause the first sensing section 33 to sense the paper characteristic of the paper conveyed through the first conveyance path 321. The controller 11 acquires the sensing result (paper characteristic information) by the size sensor 331, the paper thickness sensor 332, the basis weight sensor 333, and the moisture percentage sensor 334 from the paper characteristic sensing device 30.

Next, the controller 11 controls the paper characteristic sensing device 30 to cause the paper to be conveyed to the vertical conveyance path (second conveyance path 322) and cause the second sensing section 34 to sense the paper characteristic (step S20). The controller 31 of the paper characteristic sensing device 30 controls the conveyance section 32 and the second sensing section 34 to convey the paper from the branch section 323 to the second conveyance path 322 and to sense the paper characteristic of the paper by the second sensing section 34. The controller 11 acquires the sensing result (paper characteristic information) by the stiffness sensor 341, the surface property sensor 342, and the resistance sensor 343 from the paper characteristic sensing device 30. The controller 31 of the paper characteristic sensing device 30 controls the conveyance section 32 to cause the paper whose paper characteristic has been sensed by the second sensing section 34 to be ejected onto the purge tray 324.

As described above, during the normal printing, the paper characteristic of the paper subsequent to the paper whose paper characteristic is determined to be inconsistent with the paper characteristic of the paper to be used for the print job is sensed by the first sensing section 33 and the second sensing section 34 (seven sensors).

Here, the controller 11 determines whether or not the paper characteristic information (sensing results of the seven sensors) of the paper sensed in step S19 and step S20 is included in the second range corresponding to the paper designated in the print job (step S21). The controller 11 determines, for each of the items (size, paper thickness, basis weight, moisture percentage, stiffness, surface properties, and resistance) of the paper characteristic, whether the paper characteristic information is included in the second range. In a case in which the paper characteristic information is within the second range with respect to all the sensed items, the controller 11 determines that the sensed paper characteristic matches the paper characteristic of the paper to be used for the print job.

In a case in which the paper characteristic information of the paper sensed in step S19 and step S20 is not included in the second range (step S21; NO), the processing proceeds to step S22. In step S22, the controller 11 causes the display operation part 13 to display the error message, and stops the execution of the print job by the image forming section 14. For example, the controller 11 causes a message to be displayed which provides notification that the sensed paper characteristic does not match the paper characteristic of the paper to be used for the print job, a message to promote confirmation as to whether the paper is correctly set, or the like. Thus, the print processing ends.

In step S21, when the paper characteristic information of the paper sensed in step S19 and step S20 is included in the second range (step S21; YES), the processing proceeds to step S15. That is, as a result of performing the detailed paper characteristic sensing by the seven sensors on the next paper of the paper for which it is determined that the paper characteristics do not match, when the paper characteristics match, the controller 11 continues the normal printing while performing the simple paper characteristic sensing by the four sensors.

In step S14, in a case in which it is set that the paper characteristic is not sensed (step S14; NO), the process proceeds to step S23. In step S23, the controller 11 controls the paper feed device 20 to supply the paper from the paper feed tray 21 corresponding to the paper designated by the print job to the paper characteristic sensing device 30. The controller 11 controls the paper characteristic sensing device 30 to convey the paper supplied from the paper feed device 20 to the main body 10, and controls the image forming section 14 to perform the normal printing based on the print job. The controller 11 controls the post-processing device 40 to discharge the paper on which the normal printing has been performed to the normal paper ejection tray.

Next, the controller 11 determines whether or not there is next printing (normal printing) (step S24). In a case in which there is the next printing (step S24; YES), the process returns to step S23. The processing is repeated for the number of pages to be printed in the print job.

In step S24, in a case in which there is no next printing (step S24; NO), that is, in a case in which the normal printing based on the print job is finished, the print processing is finished.

Note that in the print processing, the paper or paper feed tray 21 to be used for the color management or the print job may be specified by the user on the screen displayed on the display operation part 13 of the main body 10 or the display part 53 of the PC 50.

### Color Management Processing in PC

FIG. 8 is a flowchart illustrating color management processing executed in the PC 50.

The color management processing is executed in a case in which the execution of the color management is instructed by the user’s operation on the operation part 54 in the PC 50. The controller 51 accepts designation of the image forming apparatus 100 to be the color management target, the type of the color management, and the like by the user's operation from the operation part 54.

The controller 51 transmits, via the communication section 55, the chart print instruction for the color management to the image forming apparatus 100 subject to the color management (step S31). The chart print instruction for the color management includes the image data of the color management chart and the setting information.

The controller 51 refers to the color management preset table T3 and identifies, in the "color management preset", the "target configuration" associated with the "image forming apparatus 100 (printer name)" to be subjected to the color management. The controller 51 generates the image data of the color management chart in accordance with the "type of color management" specified by the user.

Further, the controller 51 refers to the color management preset table T3, and acquires the "paper setting" and the "print setting" associated with the "image forming apparatus 100 (printer name)" which is the color management target in the "color management preset", and the "paper characteristic sensing setting" corresponding to the type of the current color management. The controller 51 generates the setting information from the acquired various types of information.

Next, the controller 51 determines whether it is set to perform the sensing of the paper characteristic in the current color management (step S32). Specifically, the controller 51 determines, based on the information on the "paper characteristic sensing setting" corresponding to the type of the current color management, whether the sensing of the paper characteristic is set.

In a case in which it is set to sense the paper characteristic (step S32; YES), the controller 51 acquires the paper characteristic information from the image forming apparatus 100 via the communication section 55 (step S33). The controller 51 acquires the paper characteristic information (sensing results of the seven sensors) obtained by the first sensing section 33 and the second sensing section 34 for the first paper at the time of executing the color management. For the second and subsequent paper during the execution of the color management, the controller 51 acquires the paper characteristic information obtained by the first sensing section 33 (sensing result by the four sensors).

Next, the controller 51 determines whether the paper characteristic error has been received from the image forming apparatus 100 via the communication section 55 (step S34).

In a case in which the paper characteristic error is received from the image forming apparatus 100 (step S34; YES), the controller 51 stops execution of the color management (step S35). Thus, the color management processing ends.

In a case in which the paper characteristic error is not received from the image forming apparatus 100 in step S34 (step S34; NO), the controller 51 determines whether a chart printing end notification is received from the image forming apparatus 100 via the communication section 55 (step S36).

In a case in which the chart printing end notification is not received from the image forming apparatus 100 (step S36; NO), the process returns to step S33.

In step S36, in a case in which the chart printing end notification is received from the image forming apparatus 100 (step S36; YES), the controller 51 acquires the color measurement data (colorimetric value) from the colorimeter 60 via the color measurement data receiver 56 (step S37). Specifically, the user sets the chart on the colorimeter 60, and instructs the start of the color measurement of the chart by the operation from the operation part 54. The controller 51 refers to the target configuration table T2 and causes the colorimeter 60 to measure the color of each patch of the color management chart on the basis of the "target configuration" for the color management.

Next, the controller 51 executes the color management for the image forming apparatus 100 (image forming section 14) on the basis of the color measurement data of the chart (step S38). Here, the controller 51 executes the color management based on the "target configuration" related to the color management.

In a case in which the "color verification" is executed as the color management, the controller 51 compares a colorimetry result of the chart with the target value and verifies whether or not the standard of the color verification is satisfied.

In a case in which the "color adjustment" is executed as the color management, the controller 51 adjusts the color printed by the image forming apparatus 100, based on the color measurement data of the chart.

In a case in which the "color parameter creation" is executed as the color management, the controller 51 creates the color parameter indicating the color reproduction characteristic of the image forming apparatus 100, based on the color measurement data of the chart.

Next, the controller 51 determines whether or not the color management executed in step S38 is the color parameter creation (step S39).

In a case in which the color management is the color parameter creation (step S39; YES), the controller 51 embeds the paper characteristic information acquired from the image forming apparatus 100 in the created color parameter (step S40).

For example, in a case in which an ICC profile is created based on a specification of the ICC, the controller 51 describes the paper characteristic information corresponding to each sensor in a private tag of the ICC profile, thereby embedding the paper characteristic information in the ICC profile.

Further, the color conversion profile to be created may be a structured document file, and the controller 51 may create an extensible markup language (XML) file as the structured document file. In this case, the controller 51 converts the ICC profile into text, and describes the ICC profile converted into text and the paper characteristic information in the XML file. The controller 51 describes the paper characteristic information in a tag for describing the paper characteristic information in the XML file, thereby embedding the paper characteristic information in the XML file.

Further, the controller 51 may embed the paper characteristic information in the color conversion profile by including the paper characteristic information in the file name of the color conversion profile.

The paper characteristic information acquired from the image forming apparatus 100 includes the paper characteristic information (sensing results of the seven sensors) acquired from the first paper at the time of execution of the color management and the paper characteristic information (sensing results of the four sensors) acquired from the second and subsequent paper. The controller 51 may embed all of the paper characteristic information in the color parameter, or may embed only a part of the paper characteristic information in the color parameter. For example, the controller 51 may embed only the paper characteristic information acquired from the first paper at the time of execution of the color management in the color parameter. Specifically, the controller 51 records the paper characteristic information in the predetermined tag of the device link profile. Thereafter, the controller 51 may read the paper characteristic information recorded in the predetermined tag of the device link profile, and present it to the user.

After step S40 or in step S39, in a case in which the color management is not the color parameter creation (step S39; NO), the color management processing ends.

In a case in which it is set not to sense the paper characteristic in step S32 (step S32; NO), the controller 51 determines whether or not the chart printing end notification has been received from the image forming apparatus 100 via the communication section 55 (step S41).

In a case in which the chart printing end notification is not received from the image forming apparatus 100 (step S41; NO), the process returns to step S41.

In step S41, in a case in which the chart printing end notification is received from the image forming apparatus 100 (step S41; YES), the controller 51 acquires the color measurement data (colorimetric value) from the colorimeter 60 via the color measurement data receiver 56 (step S42).

Next, the controller 51 executes the color management for the image forming apparatus 100 (image forming section 14) on the basis of the color measurement data of the chart (step S43).

The details of the processing in step S42 and step S43 are the same as the processing in step S37 and step S38. After step S43, the color management process ends.

As described above, according to the present embodiment, the controller 11 of the image forming apparatus 100 (main body 10) acquires the information on the paper characteristic sensed by the paper characteristic sensing device 30 for the paper used for the color management. The controller 11 controls the execution of the color management based on the paper characteristic information. In this way, the controller 11 controls the execution of the color management after acquiring the paper characteristic information with respect to the paper used for the color management, and thus it is possible to secure accurate color reproducibility in the color management. The controller 11 can realize accurate color management by preventing the error in setting the paper in the paper feed tray 21 and the error in selecting the paper feed tray 21. For example, the controller 11 can prevent the color management from being executed using an inappropriate paper in a case in which the paper having the characteristic different from that of the paper set as the paper used for the color management is mixed in a bundle of the paper, in a case in which the state of the paper is largely changed in the paper feed tray 21, or the like.

Note that the control of the execution of the color management based on the paper characteristic information includes not only the control as to whether or not to execute the color management but also the control as to what processing is accompanied by the color management or what processing after the color management is to be performed.

The controller 11 acquires the paper characteristic information from the paper characteristic sensing device 30 for the first paper of the paper used for the color management.

In a case in which the paper characteristic information is not included in the first range, the controller 11 provides the notification that the paper characteristic information is not included in the first range. Thus, the controller 11 can warn the user that the paper to be used for the color management is wrong.

In a case in which the paper characteristic information is not included in the first range, the controller 11 prohibits the execution of the color management by the PC 50. Thus, the controller 11 can prevent the color management from being executed using the wrong paper.

The controller 11 acquires the information on the paper characteristic sensed in the second mode by the paper characteristic sensing device 30 for the first paper of the paper used for the color management. The controller 11 acquires the information on the paper characteristic sensed by the paper characteristic sensing device 30 in the first mode for the second and subsequent paper of the paper used for the color management. As described above, the controller 11 can strictly check the first paper by acquiring the detailed paper characteristic information so that there is no error in the paper used for the color management. Furthermore, the controller 11 can reduce waste of the paper by switching to the simple confirmation of the paper characteristic for the second and subsequent paper.

In the color management preset stored in the storage section 52 of the PC 50, whether or not the sensing by the paper characteristic sensing device 30 is performed at the time of the execution of the color management is set. Thus, the image forming apparatus 100 (main body 10) and the PC 50 can determine, based on the set information, whether to sense the paper characteristic.

In addition, for each of the color verification, the color adjustment, and the color parameter creation, whether or not the sensing is performed by the paper characteristic sensing device 30 is set. Accordingly, the image forming apparatus 100 (the main body 10) and the PC 50 can determine whether or not to perform the sensing by the paper characteristic sensing device 30 for each type of the color management.

In a case in which the color parameter creation for the image forming section 14 of the image forming apparatus 100 (main body 10) is executed as the color management, the controller 51 of the PC 50 records the information on the paper characteristic sensed by the paper characteristic sensing device 30 in association with the created color parameter. Thus, the controller 51 can record the paper characteristic information of the paper used for creating the color parameter.

The controller 11 acquires the paper characteristic information from the paper characteristic sensing device 30 for the paper used for the print job.

In a case in which the paper characteristic information is not included in the second range, the controller 11 provides a notification that the paper characteristic information is not included in the second range. Thus, the controller 11 can warn the user that the paper to be used for the print job is wrong.

In a case in which the paper characteristic information is not included in the second range, the controller 11 prohibits the execution of the print job. Thus, the controller 11 can prevent the print job from being executed using the wrong paper.

Since the second range used in the execution of the print job is wider than the first range, the controller 11 can check the paper characteristic under stricter conditions in the execution of the color management than in the normal printing.

Note that the description in the above embodiments are examples of the color management method, the color management apparatus, and the storage medium including the program, and the present invention is not limited thereto. The detailed configuration and detailed operation of each device constituting the system can also be appropriately changed. In addition, in the image forming apparatus 100, a configuration included in a general image forming apparatus is not excluded.

For example, in the color management preset, the "paper characteristic sensing setting" set for each color management type (color management function) may be the different setting for each paper characteristic sensing mode (first mode or second mode) in the same color management type. Specifically, during the execution of the color management, the "paper characteristic sensing setting" may be changed between a case where the paper characteristic is sensed by only the first sensing section 33 (first mode) and a case where the paper characteristic is sensed by the first sensing section 33 and the second sensing section 34 (second mode). In other words, during execution of the color management, "paper characteristic sensing setting" may be changed between a case in which the paper is conveyed to the main body 10 and a case in which the paper is ejected to the purge tray 324 via the vertical conveyance path (second conveyance path 322). However, the conveyance itself of the paper is not performed in a case in which it is set to not perform the sensing of the paper characteristic for the second mode.

Furthermore, in the above-described embodiment, the color management preset includes the "target configuration" and the "paper characteristic sensing setting", and thus the "target configuration" and the "paper characteristic sensing setting" are associated with each other. Alternatively, the "target configuration" and the "paper characteristic sensing setting" may be associated with each other by including the "paper characteristic sensing setting" in the "target configuration".

According to the above-described embodiment, an example in which the first sensing section 33 includes four sensors of the size sensor 331, the paper thickness sensor 332, the basis weight sensor 333, and the moisture percentage sensor 334 has been described, but the invention is not limited thereto. Furthermore, at least one sensor of the first sensing section 33 may be disposed on the downstream side of the branch section 323 in the first conveyance path 321.

The above embodiment is described with the example in which the second sensing section 34 includes the stiffness sensor 341, the surface property sensor 342, and the resistance sensor 343, but it is not limited thereto.

According to the above-described embodiment, a case has been described in which the color management software is installed in the PC 50, and the PC 50 executes the color management (acquisition of colorimetric value, color verification, calculation of adjustment value, and the like). Alternatively, the color management software may be installed in the main body 10 of the image forming apparatus 100, and the main body 10 may execute the color management. In this case, the image forming apparatus 100 is the "color management apparatus" including the image forming section 14 and the sheet characteristic sensing section (first sensing section 33 and second sensing section 34).

Further, in the above-described embodiment, the PC 50 manages the target configuration and the color management preset. In a case in which the color management software is installed in the main body 10 of the image forming apparatus 100, the target configuration and the color management preset may be managed on the image forming apparatus 100 (main body 10) side.

Furthermore, in the embodiment described above, the PC 50 and the image forming apparatus 100 cooperate to constitute the "color management apparatus". Alternatively, in the above-described embodiment, some or all of the processes performed by the PC 50 and the image forming apparatus 100 may be performed by another apparatus. Alternatively, a single device may include all the functions of the "color management apparatus".

According to the above-described embodiment, the colorimeter 60 performs the color measurement of each patch of the color management chart outside the image forming apparatus 100. Alternatively, in the image forming apparatus 100, the color measurement of each patch of the color management chart may be performed by an in-line colorimeter provided in the conveyance path along which the paper after the image formation is conveyed.

Further, means and methods for performing various processes in the image forming apparatus 100 and the PC 50 can be realized by any of a dedicated hardware circuit or a computer according to a program. The program may be provided, for example, by a computer-readable recording medium such as a USB memory or a DVD-ROM, or may be provided online via a network such as the Internet. In addition, the program may be provided as independent application software, or may be incorporated into software of the apparatus as one function of the apparatus.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A color management method in a color management apparatus that performs color management including at least one of color verification, color adjustment, and color parameter creation for an image former, the color management method comprising:
acquiring sheet characteristic information regarding a sheet characteristic sensed by a sheet sensor for a sheet used in the color management; and
controlling execution of the color management based on the acquired sheet characteristic information.

2. The color management method according to claim 1, wherein,
a first reference range regarding the sheet characteristic is registered in advance for the sheet used in the color management,
when performing the color management,
the sheet characteristic information regarding the sheet characteristic sensed by the sheet characteristic sensor is acquired for the first sheet of the sheet used in the color management, and
in a case in which the sheet characteristic information is not included in the first reference range, it is notified that the sheet characteristic information is not included in the first reference range, or the execution of the color management is prohibited.

3. The color management method according to claim 1, wherein,
the sheet characteristic sensor includes a first mode configured to be capable of sensing the sheet characteristic related to a first combination and a second mode configured to be capable of sensing more of the sheet characteristic than the first combination,
for a first sheet of the sheet used in the color management, the sheet characteristic information regarding the sheet characteristic sensed by the sheet characteristic sensor in the second mode is acquired, and
for a second and subsequent sheet of the sheet used in the color management, the sheet characteristic information regarding the sheet characteristic sensed by the sheet characteristic sensor in the first mode is acquired.

4. The color management method according to claim 1, wherein,
it is set whether to perform sensing by the sheet characteristic sensor as a setting value of a data set used in the color management,
in a case in which it is set to perform the sensing by the sheet characteristic sensor,
for the sheet used in the color management, the sheet characteristic information regarding the sheet characteristic sensed by the sheet characteristic sensor is acquired, and
the execution of the color management is controlled based on the acquired sheet characteristic information.

5. The color management method according to claim 4, wherein, as a setting value of a data set used for the color management, it is set whether to perform sensing by the sheet characteristic sensor for each of the color verification, the color adjustment, and the color parameter creation.

6. The color management method according to claim 1, wherein, in a case in which the color parameter creation for the image former is executed as the color management, the sheet characteristic information regarding the sheet characteristic sensed by the sheet characteristic sensor is recorded in association with a created color parameter.

7. The color management method according to claim 6, wherein the sheet characteristic information regarding the sheet characteristic sensed by the sheet sensor is embedded in information of the created color parameter.

8. The color management method according to claim 2, wherein,
a second reference range related to a sheet characteristic is registered in advance for a sheet used in a print job by the image former,
the second reference range is wider than the first reference range,
when the execution of the print job is performed by the image former,
for the sheet used in the print job, the sheet characteristic information regarding the sheet characteristic sensed by the sheet characteristic sensor is acquired, and
in a case in which the sheet characteristic information is not included in the second reference range, it is notified that the sheet characteristic information is not included in the second reference range, or the execution of the print job is stopped.

9. A color management apparatus for executing the color management method according to claim 1.

10. The color management apparatus according to claim 9, further comprising,
an image former; and
a sheet characteristic sensor.

11. A non-transitory computer-readable storage medium storing a program for causing a computer that controls a color management apparatus to execute the color management method according to claim 1.
